(19) United States
(12) Patent Application Publication
(10) Pub. No.: US 2004/0093509 A1
(43) Pub. Date: May 13, 2004

(54) Method and apparatus for connecting a storage device to a television

(76) Inventors: Gidon Elazar, Tsur-Igal (IL); Dan Harkabi, Moshav Lachish (IL); Nehemiah Weingarten, Tel-Aviv (IL)

Correspondence Address: Nehemiah Weingarten (MDRM), c/o Yael Hilerowitz-Gur, FAHN KANEH CONSULT, 23 Petach-Tikva Road, Tel-Aviv, 66184, IL

(21) Appl. No.: 10/703,471

(22) Filed: Nov. 10, 2003

Related U.S. Application Data
(60) Provisional application No. 60/425,704, filed on Nov. 12, 2002.

(51) Int. Cl. H04N 7/167

(52) U.S. Cl. 713/200; 380/201

(57) ABSTRACT

A method and apparatus for presentation of copyrighted digital content on a visual display unit is disclosed. Various embodiments include a method and an apparatus for connecting a digital storage device to a television, such that content from the storage device is presented on the television. Content is transferred from a storage device such as a flash memory device, hard disk, or other storage device to the apparatus. The content is processed inside the apparatus, which eventually produces a video signal that is sent to the television for presentation. The apparatus may store the content or part of the content for future use. The apparatus may be controlled, for example it can be instructed which content to process and send to the television to be presented.

### RELATED U.S. APPLICATION

This application claims the benefit of provisional patent applications serial No. 60/425,704, filed Nov. 12, 2002.

This application is related to patent application Ser. No. 10/227,155 filed Aug. 23, 2002.

### FIELD OF THE INVENTION

This invention generally relates to television accessories. More particularly this invention relates to methods and apparatuses for presenting copyrighted digital content such as images, video, audio, and electronic books on a television screen.

### BACKGROUND OF TH INVENTION

A television appliance is one of the most popular consumer electronic appliances, being present in a high percentage of households worldwide. Currently, most of the television appliance installed base uses analog video technology, enabling distribution of content in an analog format Although the present installed base of High Definition Television (HDTV) is relatively small, HDTV also represents another form of distribution of content Other types of visual display units are being developed today as well.

Over the last decade digital appliances such as personal computers, personal digital assistants (PDAs), digital cameras and the like have become widely available and popular, enabling the creation, manipulation and use of various types of content in a digital format.

The Internet worldwide network adds to digital content proliferation by allowing easy distribution of digital files and specifically digital content files such as digital books, documents, images, video or voice and music files. These files may be transmitted through the network to digital appliances and used by end user consumers.

The proliferation and distribution of digital content is substantial. In many cases the digital content is copyrighted. Various devices, computer programs and methods are available to use digital content in digital format, such as to listen to music, view pictures, watch movies and read books, and an increasing number of content files exist in digital form. In order to use such content, there is a need for a digital appliance, such as a personal computer, PDA, portable DVD player and the like. However, the worldwide proliferation of such devices is not as widespread as the proliferation of the Television.

Furthermore, the usage of the television appliance for content applications, such as viewing images and video, is an established human behavior, whereas using a digital appliance, such as a personal computer, to use content, for example viewing digital images, is behavior that is not as established and may be perceived as an inconvenient or less social experience. The personal computer is a convenient environment for managing various types of digital content, for example distributing, collecting, archiving, editing or the like operations, but not necessarily for using them, for example viewing pictures and movies, or listening to music.

Digital storage devices, such as magnetic hard drives, floppy disks, flash memory cards, flash memory USB storage devices are used to store digital files, such as digital content files. Digital storage devices are far more abundant than electronic appliances such as personal computers due to their low cost In some occasions, people that do not own an electronic appliance, such as a computer, own a digital storage device where they can store their personal files, for example a digital camera with a removable flash memory. In many cases though, digital storage devices are designed to attach to a personal computer or other personal computation device.

Several products attempt to enable the display of digital images on a television. For example, some models of digital cameras can connect to a television and display photos. An example is Sony's Mavica. Unfortunately, digital cameras are designed to display the photos just taken and not pictures that have been previously stored, manipulated and/or managed on a personal computer.

Other products accept the flash memory card from the digital camera and communicate the data to the television for display. Examples of such products are Lexar's digital photo player (http://www.digitalfilm.com/digitalacc/index_jd.html), Delkin's Picturevision (http://www.delkin.com/products/picturevision/pictVIS_moreinfo.htm0), Sandisk Digital Photo Viewer (http://www.sandisk.com/consumer/dpv.asp), or Visioneer's PhotoPort (http://www.visioneer.com/Products/photoporttv/home.html).

Unfortunately, these devices are geared toward personal image and personal video viewing and not for use with other content such as electronic books or commercial movies.

Furthermore, these display devices are not specifically designed to handle copyrighted digital content.

Furthermore, these display devices are designed to accept flash memory cards used in digital cameras and are not designed to accept digital storage devices that are usually associated with a personal computer, such as USB flash disks, USB magnetic disks, or other storage devices that may be used to store information from a personal computation device.

Furthermore, these display devices are designed to be placed in fixed locations and not to be carried as portable handheld devices.

There is clearly an unmet need for a device and a method to enable the presentation on a television appliance of copyrighted digital content stored on a digital storage device.

### SUMMARY OF THE INVENTION

The TV Imager device can be connected or coupled to a storage device and/or to a video input of a television appliance or the like visual display unit. The storage device stores copyrighted digital content files, such as electronic books, images, music and/or video and may have the capabilities to process the copyrighted content for example to enable or disable the presentation of such content. Some embodiments of TV imagers include an internal storage device.

The TV Imager retrieves one or more digital content files or one or more parts of one or more digital content files such as digital images or digital videos, from the storage device, converts the files to a video and/or audio signal and/or transmits the signal to a television appliance for presentation.

If the digital content is protected by copyright, the storage device verifies the rights to use the digital content prior to processing and/or transmitting the digital content to the TV Imager.

According to some embodiments, the TV Imager device further comprises human interface components, such as switches, buttons, displays, lights and/or an infrared control to enable selection of which content file or part of a file to display.

In some embodiments, various manipulations may be executed upon on the content for example turning a page in an electronic book, volume, zoom, or other functions.

In some embodiments, the TV Imager may be handheld and used in a plurality of locations where there exists a television appliance.

In other embodiments, the TV Imager may be stationary in its location, similar to a set-top-box which is designed to be located in proximity to the television.

### BRIEF DESCRIPTION OF THE DRAWINGS

The foregoing and other objects, aspects and advantages will be better understood from the following detailed description of an embodiment of the invention with reference to the drawings, wherein:

FIG. 1 is a schematic block diagram of an exemplary embodiment of the TV Imager device;

FIG. 2 is a flowchart of an exemplary method for presenting images on a television appliance using the TV Imager device of FIG. 1.

FIG. 3 is a flowchart of an exemplary method for presenting copyrighted electronic content on a television appliance using the TV Imager device of FIG. 1.

FIG. 4 is a flowchart of an exemplary method for reading an electronic book on a television appliance using the TV Imager device of FIG. 1.

### DETAILED DESCRIPTION OF THE INVENTION

In the following detailed description of exemplary embodiments of the invention, reference is made to the drawings that illustrate specific exemplary embodiments in which the invention may be practiced. Those skilled in the art will appreciate that other embodiments may be utilized without departing from the spirit of the present invention; therefore the following detailed description of the invention should not be taken in a limiting sense. In various embodiments, there may be none, one, or more than one of the following described parts. Further, the parts can be modified and/or rearranged. In various embodiments, methods can have additional actions, fewer actions, actions in a different order, and/or modified actions. The scope of the invention is defined only by the appended claims.

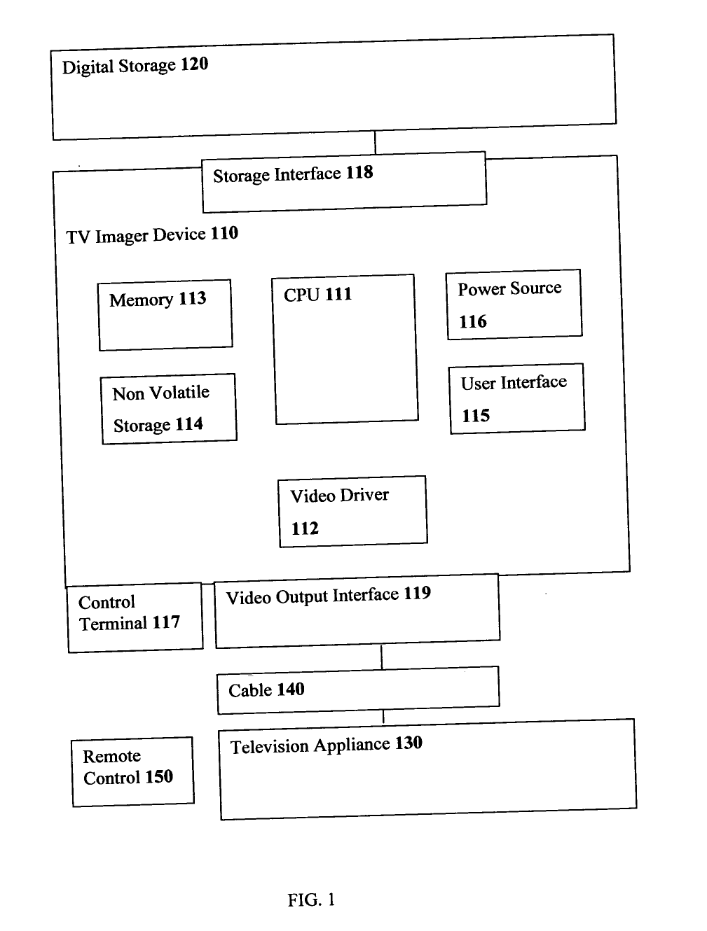

FIG. 1 is a diagram of an exemplary embodiment of the TV Imager Device 110 hardware, which includes a central processing unit (CPU) 111, a video driver 112, an optional system memory 113, an optional non-volatile storage 114, an optional user interface 115, a power source 116, an optional control interface 117, a storage interface 118 to connect the device 110 to a digital storage 120, and/or a output terminal 119 to connect the device 110 to a television appliance 130 through an optional cable 140. According to some embodiments of TV Imager Device 110, an optional remote control 150 is included. There may be only one or a plurality of central processing units 111, as there may optionally be only one or a plurality of video drivers 112, system memory 113, non-volatile storage 114, user interface 115, power source 116, or control interface 117. There may be only one or a plurality of storage interfaces 118 and there may be one or a plurality of output terminals 119; the invention is not so limited. The memory 113 or video driver 112 may be included in the CPU 111 or be discrete from the CPU 111; generally, components or subcomponents of the TV Imager Device 110 hardware may be combined with other components or subcomponents of the TV Imager device for higher integration and perhaps lower cost.

The CPU 111 may be a general purpose CPU or a CPU with dedicated functions. Furthermore the CPU 111 may include internal memory, and/or internal non-volatile storage that may serve a similar purpose of the system memory 113, and/or the non-volatile storage 114 respectively. The CPU 111, the non-volatile storage 114, and/or other components may be implemented as a tamper resistant hardware, or sections of the CPU 111, the non-volatile storage 114, and/or other components may be tamper resistant; the invention is not so limited.

The video driver 112 converts a digital representation of a video image to a video signal that can be transmitted to a television appliance 130. Examples for video driver components are Analog Devices ADV7121 (http://products.analog.com/products/info.asp?product=ADV7127) or ADV7170 (http://products.analog.com/products/info.asp?product=ADV7170). The CPU 111 streams information into the video driver 112, or the video driver 112 receives the data directly from the system memory through a direct memory access (DMA), it may be appreciated by those skilled in the art that there exist a plurality of methods to stream data into the video driver 112. Various embodiments can support video signals in one or more of the following formats: NTSC, PAL, SECAM, HiVision, HDTV and other video formats; the invention is not so limited.

A Visual Display Unit is an electronic device for visual presentation of content such as video, images, and the like. Examples are a television appliance, a projector, a computer monitor, and the like. Although various exemplary embodiments hereafter refers to television appliances, this invention should be considered in a broader sense to include all types of Visual Display Units.

The non-volatile storage 114 may be any of several types of storage including semiconductor based media such as read only memory (ROM), electronic erasable programmable read only memory (EEPROM), flash memory or battery backed up random access memory (RAM); or magnetic media storage such as hard disk drive or floppy disk, or the like. One of the purposes of non-volatile storage 114 can be to store the instruction set used by CPU 111.

According to some embodiments, under certain conditions, non-volatile storage 114 may be updated, for example with a new instruction set.

The storage interface 118 can connect the TV Imager device 110 with a digital storage 120 in physical and/or communication aspects. The physical aspect can be, for example directly, through one or more cables, and/or wireless. The communication aspect of the storage interface 118 allows data exchange between the TV Imager device 110 and the digital storage 120. The storage interface 118 may be any of several types of interfaces, for example PCI, ISA, Universal Serial Bus (USB), FireWire, IDE, SCSI, RS-232 or other serial interface, parallel interface, Smart Media, Compact Flash (CF) interface, Sony Memory Stick interface, Multimedia Card (MMC), secure digital (SD), mini secure digital (Mini SD), extreme Digital (xD), Bluetooth, WiFi, ultrawideband, Infiniband, and/or any other type of interface that may be used to connect a TV Imager device with a digital storage.

In some embodiments, the TV Imager device 110 includes the functionality of a USB host, compliant with the USB Specification Rev. 2.0 full speed and low speed, USB On the Go revision 1.0, and/or compliant with USB Specification 1.1 (hereafter all three shall be addressed as USB. In this case, storage interface 118 is a USB compliant interface.

The digital storage 120 is a portable storage device. A portable storage device is a storage device external to the consumer electronic device with which it operates, and may be ported to work with more than one consumer electronic device. Examples are USB flash drives, SD cards, miniSD cards, and the like.

A Digital Content File is data which has an end use of being heard, viewed, read by, and/or otherwise experienced by an end user, and at some point prior to end use is stored and/or represented in numerical form.

A Copyrighted Digital Content File is a Digital Content File which has legal limitations on at least one end use. For example, a user may not create a copy of, distribute, modify, sell, and/or perform other end uses of a Copyrighted Digital Content File, without receiving permission from the copyright owner. Examples of Copyrighted Digital Content Files are commercial movies, commercial music, electronic books, and the like.

In some embodiments, digital storage 120 contains one or a plurality of Copyrighted Digital Content Files with their corresponding copyright policies. TV Imager device 110 sends request for content to the storage device 120 which processes the copyright policies to determine the eligibility for the content prior fulfilling the request Examples of policies are use only once, use until certain expiration date, use for a certain amount of time, and other options for restricting and/or controlling the presentation of the Copyrighted Digital Content on television appliance 130.

In some embodiments digital storage 120 may contain non-copyrighted digital content; this invention is not so limited.

In some embodiments, where TV Imager device 110 includes the functionality of a USB host, the digital storage 120 may be a USB compliant device. As such, TV Imager device 110 will implement USB mass storage class protocols as defined by the USB organization http://www.usb.org. Examples of mass storage class specifications are USB Mass Storage Class Control/Bulk/Interrupt (CBI) Transport, USB Mass Storage Class Bulk-Only Transport, USB Mass Storage Class ATA Command Block, and USB Mass Storage Class UFI Command Specification. TV Imager 110 may implement none, one, or more than one of the above protocols, or other mass storage class protocols. In these cases, digital storage 120 may be preloaded with content when connected to a PC, prior to use with TV Imager device 110.

Examples of digital storage 120 as a USB compliant device are External Hard Drive by Pocketec http://www.pocketec.net/catalog.taf?f=products&cat=PHD. Keychain flash memory devices such as Sony MicroVault http://www.sony.net/Products/Microvault/, or a digital camera with USB cable for interface with PC, for example Olympus D-380 http://www.olympusamenca.com/cpg_section/cpg_productasp?huge_picture_. There may be other types of USB compliant devices storing content that may be used with TV Imager device 110, this invention is not so limited.

Further, in embodiments where TV Imager device 110 includes the functionality of a USB host, user does not need to posses a content creation device such as digital camera or a digital video recorder, as content may be created on or transferred from various sources over the Internet to a PC connected to storage device 120 that will later attach to TV Imager device 110 for presentation of digital content.

The non-volatile storage 114 and/or the system memory 113 contain instructions that may be executed by the CPU 111. The non-volatile storage 114 and/or the system memory 113 may further contain a copy of all or part of the digital content files or sections of all or part of such files. The non-volatile storage 114 and/or the system memory 113 may contain an intermediate processed form of one or more digital content files or sections of files, for example an image file that is to be translated into a video signal to be sent to the television appliance 130.

In some embodiments, the digital content may be prepared on a PC, and then transferred to digital storage 120 for use with TV Imager device 110. An example of such preparation is formatting of images or video to a resolution fit for television screens. The advantage of such manipulation is the saving of computation power needed from CPU 111, making content presentation time on a television appliance faster, and/or enabling the use of a cheaper CPU 111 component.

The power source 116 provides power to the components of the TV Imager device 110 and optionally to the digital storage 120 through the storage interface 118. According to some embodiments, the power source couples to a power network outlet. According to some embodiments, the power source is a battery or a plurality of batteries internal to the TV Imager device. According to another embodiment, the battery or plurality of batteries may be rechargeable, whether recharged when placed in the TV Imager device, or in a separate battery re-charger, this invention is not so limited. According to another embodiment the power source is external to the TV imager, for example an external power supply or transformer. It may be appreciated by those skilled in the art that there exist other methods to implement the power source 116 of the TV Imager device 110.

The user interface 115 enables input of user requests and/or output of status information. The user interface 115 may be any of several types including buttons, switches, knobs, displays, lights, LEDs or the like.

According to some embodiments, the user interface 115 is limited to very few buttons, switches, knobs, displays, lights, LEDs or the like, so that the functionality provided is very basic. The aim is to enable non-technology literate users the ability to use and enjoy TV Imager Device 110.

The output terminal 119 is used to connect the TV Imager to a television appliance 130. According to one embodiment, the connection is direct, such as a to a television video input connector. According to another embodiment, the connection is through cable 140. The output terminal 119 enables transmission of a video signal to the television appliance 130 and may be any of several types of interfaces including A/V video, composite video, S-video, component video, coaxial, a custom made interface, and/or any other interface that may be used to connect the TV Imager device 110 to a television appliance 130 or to a cable 140. The output terminal 119 may transmit video and/or audio and/or other signals that may be used by the television appliance 130 for presentation. It may be appreciated by those skilled in the art that there exist a variety of such optional interfaces.

The optional cable 140 enables video signal to be transmitted from the TV Imager 110 to the television appliance 130. Cable 140 has two ends; one connects to the output terminal 119 and the other to the television appliance 130. Cable 140 can be formed by connecting a plurality of cables, this invention is not so limited. The end that connects to the output terminal 119 of the TV Imager 110 has a connector that matches the connector of the output terminal 119. The end that connects to the television appliance 130 has a connector that may be any of several types of connectors including A/V video, composite video, S-video, component video, coaxial or any other interface that may be used to connect a cable to a video input of a television appliance. In some embodiments, the TV Imager may be held in the hands' of the user. The cable 140 can run from the location of the user to the television appliance 130. In various embodiments, the cable 140 has a length of 180 cm, more than 180 cm, or less than 180 cm. Shorter cables may restrict convenient operation.

The control interface 117 enables transmission or reception of control commands and/or status information. Examples of such control commands include power on, power off, mute on, mute off, system change or selection of the appropriate video input source and/or the like. This embodiment enables users to set the television appliance 130 into an appropriate mode and/or enables convenient operation.

According to some embodiments, the control interface 117 enables transmission or reception of user control requests and/or status information in a wireless fashion.

According to some embodiments, the control interface 117 may be any of several types of wireless input and/or output devices including infra-red, radio, bluetooth, WiFi, ultrawideband, laser and/or other components that can transmit and/or receive data in a wireless fashion, this invention is not so limited. These embodiments enable the TV Imager 110 to be controlled by an optional remote control 150 or other remote controls.

According to some embodiments, the remote control 150 may send commands to the TV Imager 110 through the control interface 117, and/or the TV Imager 110 may send responses and/or status information to the remote control 150 through the control interface 117. Examples of such control commands include power on, power off, mute on, mute off, system change or video input source selection and/or the like.

According to some embodiments the control terminal 117 accepts commands from a remote computational device, such as a personal computer, a PDA, a set top box, and the like. The TV Imager device 110 may respond to such commands by sending responses and/or status information through the control interface 117.

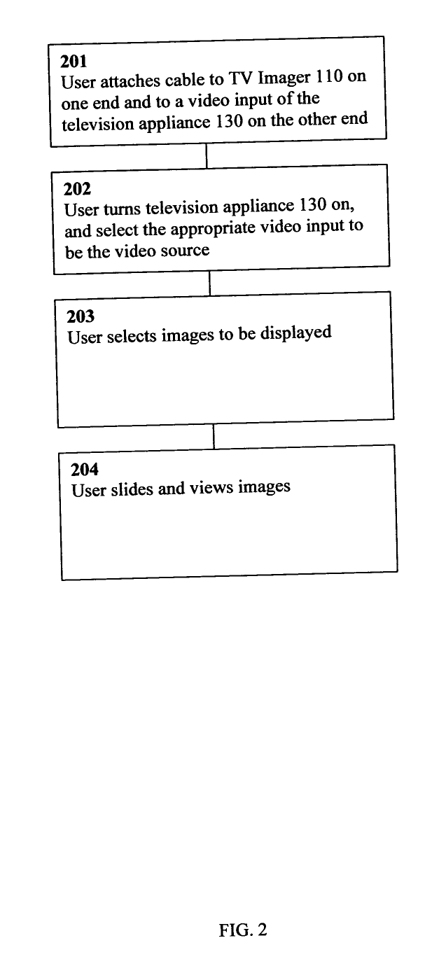

FIG. 2 is a flow chart describing an exemplary sequence of operations carried out when a user operates the TV Imager device 110 to view images. In step 201 the user attaches the cable to the TV Imager device 110 at one end and the television appliance 130 on the other end. In step 202 the user turns on the TV Imager device 110 and uses it to turn on the television appliance 130, select the appropriate video input source and/or mute the television appliance 130 sound. In step 203 the user selects the images for viewing. In step 204 user views images one at a time or as a slide show or as preferred.

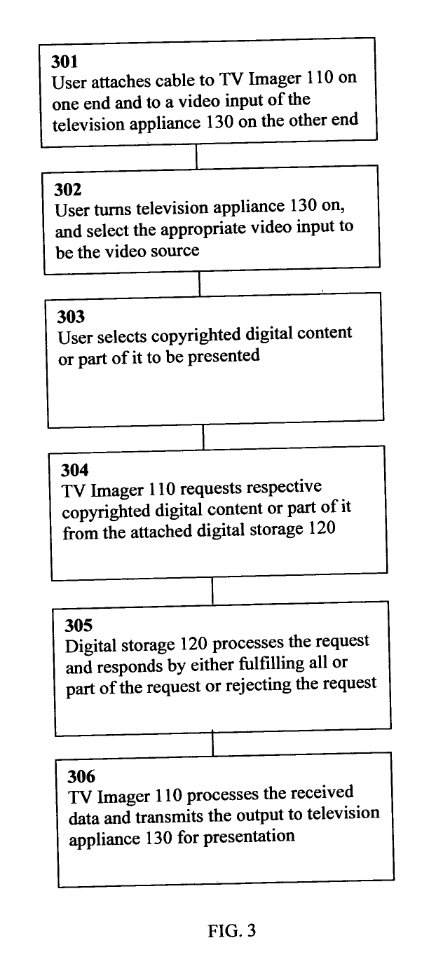

FIG. 3 is a flow chart describing an exemplary sequence of operations carried out when a user operates the TV Imager device 110 to present copyrighted content on a television appliance 130. In step 301 the user attaches the cable to the TV Imager device 110 at one end and the television appliance 130 on the other end. In step 302 the user turns on the TV Imager device 110 and uses it to turn on the television appliance 130, select the appropriate video input source and/or mute the television appliance sound. In step 303 the user selects the copyrighted digital content or a section of it to be presented. In step 304 the TV Imager device 110 requests the required copyrighted digital content from the digital storage 120. In step 305 the digital storage 120 processes the request and responds with either fulfilling all or part of the request or rejecting the request. In step 306 the TV Imager device 110 processes the received data and transmits the output to the television appliance 130 for presentation.

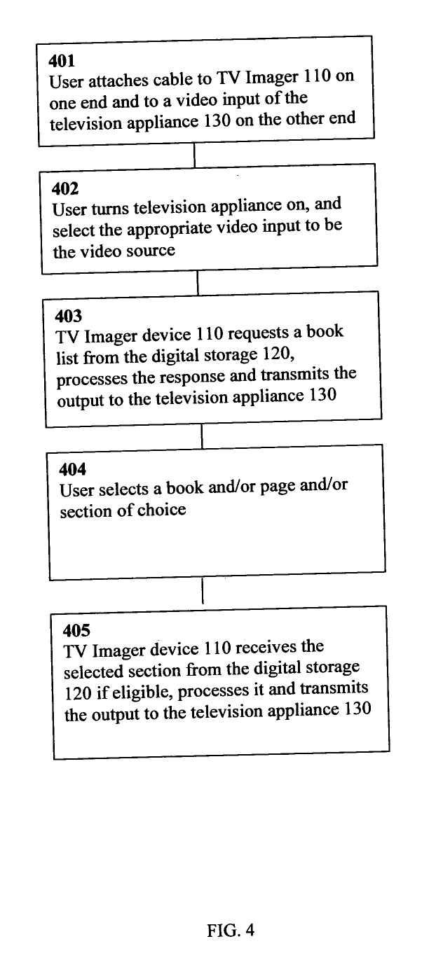

FIG. 4 is a flow chart describing an exemplary sequence of operations carried out when a user operates the TV Imager device 110 to read an electronic book. In step 401 the user attaches the cable to the TV Imager device 110 at one end and the television appliance on the other end. In step 402 the user turns on the TV Imager device 110 and uses it to turn on the television appliance 130, select the appropriate video input source and/or mute the television appliance 130 sound. In step 403 The TV Imager device 110 requests a book list from the digital storage 120, processes the response and transmits the output to the television appliance 130. In step 404 the user selects a book and/or page and/or section of choice using the user interface 115 and/or the remote control 150 and/or other control. In step 405 the TV Imager device 110 receives the selected section from the digital storage 120 if eligible, processes it and transmits the output to the television appliance 130.

We claim:

1. An apparatus for presentation of copyrighted digital content on a visual display unit, the apparatus comprising:
one or more storage interface for coupling with a portable storage device wherein said portable storage device contains at least part of the copyrighted digital content to be presented on the visual display unit;
one or more control interface capable of receiving commands wherein the commands are used to control the presentation of the copyrighted digital content;
one or more output terminals capable of supplying a signal to the visual display unit; and
one or more processing units capable of receiving the copyrighted digital content from said storage device interface when coupled to a portable storage device, executing instructions to convert the copyrighted digital content into visual display unit signals compatible with the visual display unit, and by using said output terminals, transmitting the visual display unit signals to a visual display unit for presentation thereon,
wherein at least part of the copyrighted digital content is received from a portable storage device coupled to the apparatus, processed by the apparatus and presented on the visual display unit.

2. The apparatus of claim 1, wherein the apparatus is coupled to at least a visual display unit.

3. The apparatus of claim 2, wherein the visual display unit comprises a television.

4. The apparatus of claim 1, wherein the apparatus is coupled to at least a portable storage device.

5. The apparatus of claim 1, wherein the copyrighted digital content comprises at least an electronic book.

6. The apparatus of claim 1, wherein the copyrighted digital content comprises at least a video file.

7. The apparatus of claim 1, wherein the copyrighted digital content comprises at least an audio file.

8. The apparatus of claim 1, wherein the copyrighted digital content comprises at least an image.

9. The apparatus of claim 1, wherein the copyrighted digital content comprises at least a document.

10. The apparatus of claim 2, wherein the apparatus couples to said visual display unit via a physical connection to said visual display unit.

11. The apparatus of claim 10, wherein said physical connection includes one or more cables.

12. The apparatus of claim 2, wherein the apparatus couples to said visual display unit by directly physically connecting to said visual display unit.

13. The apparatus of claim 2, wherein the apparatus couples to said visual display unit by remotely connecting to said visual display unit.

14. The apparatus of claim 13, wherein the apparatus couples to said visual display unit by wirelessly connecting to said visual display unit.

15. The apparatus of claim 1, wherein the apparatus couples to a portable storage device unit by directly physically connecting to said external storage device.

16. The apparatus of claim 15, wherein said portable storage device is a USB storage device.

17. The apparatus of claim 15, wherein said portable storage device includes flash memory.

18. The apparatus of claim 1, wherein the apparatus couples to a portable storage device by remotely connecting to said portable storage device.

19. The apparatus of claim 18, wherein the apparatus couples to a portable storage device by wirelessly connecting to said portable storage device.

20. The apparatus of claim 1, wherein the presentation is at least partly visual data.

21. The apparatus of claim 1, wherein the presentation is at least partly audio data.

22. The apparatus of claim 1, further comprising an internal non-volatile storage for storing copyrighted digital content.

23. A method for presenting copyrighted digital content using a rendering apparatus for at least part of said copyrighted digital content, comprising:
requesting at least part of said copyrighted digital content from a portable storage device;
receiving none, some or all of the requested copyrighted digital content from said portable storage device;
processing at least part of the received copyrighted digital content in the rendering apparatus; and
sending at least part of the processed copyrighted digital content for presentation to a visual display unit coupled to said rendering apparatus.

24. An apparatus for presentation of copyrighted digital content on a visual display unit, the apparatus comprising:
one or more internal digital storage wherein said internal digital storage contains at least part of the copyrighted digital content to be presented on the visual display unit;
one or more control interface capable of receiving commands wherein the commands are used to control the presentation of the copyrighted digital content;
one or more output terminals capable of supplying a signal to the visual display unit; and
one or more processing units capable of receiving the copyrighted digital content from said digital storage, executing instructions to convert the copyrighted digital content into visual display unit signals compatible with the visual display unit, and by using said output terminals, transmitting the visual display unit signals to a visual display unit for presentation thereon,
wherein at least part of the copyrighted digital content is received from the internal digital storage and presented on the visual display unit.

25. The apparatus of claim 24, further comprising:
one or more storage interface for coupling with a portable storage device wherein said portable storage device contains at least part of the copyrighted digital content to be presented on the visual display unit.
